(19) United States
(12) Patent Application Publication
(10) Pub. No.: US 2008/0060498 A1
(43) Pub. Date: Mar. 13, 2008

(54) GUITAR HANGER AND NON-MECHANICAL LOCKING DEVICE

(76) Inventor: Christopher Samu, Albany, CA (US)

Correspondence Address: DERGOSITS & NOAH LLP, Four Embarcadero Center, Suite 1450, San Francisco, CA, 94111, US

(21) Appl. No.: 11/940,472

(22) Filed: Nov. 15, 2007

Related U.S. Application Data
(63) Continuation-in-part of application No. 11/210,237, filed on Aug. 22, 2005.

(51) Int. Cl. G10G 5/00

(52) U.S. Cl. 84/327

(57) ABSTRACT

A guitar hanger and non-mechanical locking device for hanging a guitar having a neck and head portion, the hanger configured for hanging a guitar from its neck portion and for minimizing inadvertent release from the hanger. The guitar hanger includes a support member and appended thereto, a set of prongs spaced apart from one another to receive the neck portion therebetween but not the head portion. The prongs are further characterized as having converging ends spaced apart from one another such that the neck is capable of passing between the prongs in a first orientation but not in a second orientation.

### PRIOR APPLICATIONS

This is a continuation-in-part of U.S. patent application Ser. No. 11/210,237 filed on Aug. 22, 2005.

### TECHNICAL FIELD

The present invention is directed to a simple yet effective device for hanging and locking a musical instrument such as a guitar in a manner which makes the musical instrument readily available to its user and yet minimizes inadvertent release from the hanger in order to effectively prevent damage.

### BACKGROUND OF THE INVENTION

Guitar access to a musician as well as guitar storage and display is more problematic than one might, at first blush, appreciate. Guitars have been available on floor stands for ready access to a musician but such stands do not effectively secure the musical instrument preventing its inadvertent release and consequent damage.

There are guitar stands which have attempted to prevent inadvertent release but such products are generally expensive, complicated and not user friendly. Multi-latch mechanisms do not facilitate a guitar's release from a stand in a simple straightforward motion and, thus, even when a securing mechanism is made available, a musician will oftentimes not use it for it doesn't provide the sought after quick and forthright release oftentimes necessary during a performance.

Similarly, guitar stores oftentimes display guitars on a wall or on a pegboard membrane by extending hooks which orient the displayed guitars vertically. Although these displays effectively promote the guitar to a prospective customer, if one was to handle the guitar or even walk past the display while inadvertently bumping the instrument, it can oftentimes fall from its support causing catastrophic damage.

It is thus an object of the present invention to provide a guitar hanger which is simple and economical to manufacture.

It is yet a further object of the present invention to provide a guitar hanger which effectively, and in a non-complex fashion, maintains a guitar on a stand or other suitable support while preventing its inadvertent release there from.

These and further objects will be more readily apparent when considering the following disclosure and appended claims.

### SUMMARY OF THE INVENTION

A guitar hanger for hanging and locking a guitar having a neck and head portion, said hanger configured for hanging said guitar from its neck portion and for minimizing inadvertent release from said hanger. The guitar hanger comprises a support member and appended thereto, a set of prongs spaced apart from one another to receive said neck portion therebetween but not said head portion. The set of prongs further is characterized as having converging ends spaced apart from one another such that said neck is capable of passing between said prongs in a first orientation but not in a second orientation.

### BRIEF DESCRIPTION OF THE FIGURES

FIG. 1 is a perspective view of a first embodiment of the present invention comprising a floor stand.

FIG. 2 is a perspective view of a second embodiment of the present invention employing a wall-mounted bracket.

FIG. 3 is a perspective view of the third embodiment of the present invention for use on a pegboard membrane.

FIGS. 4A and 4B are perspective views of a guitar being properly placed within the present invention to take advance of its locking function.

### DETAILED DESCRIPTION OF THE INVENTION

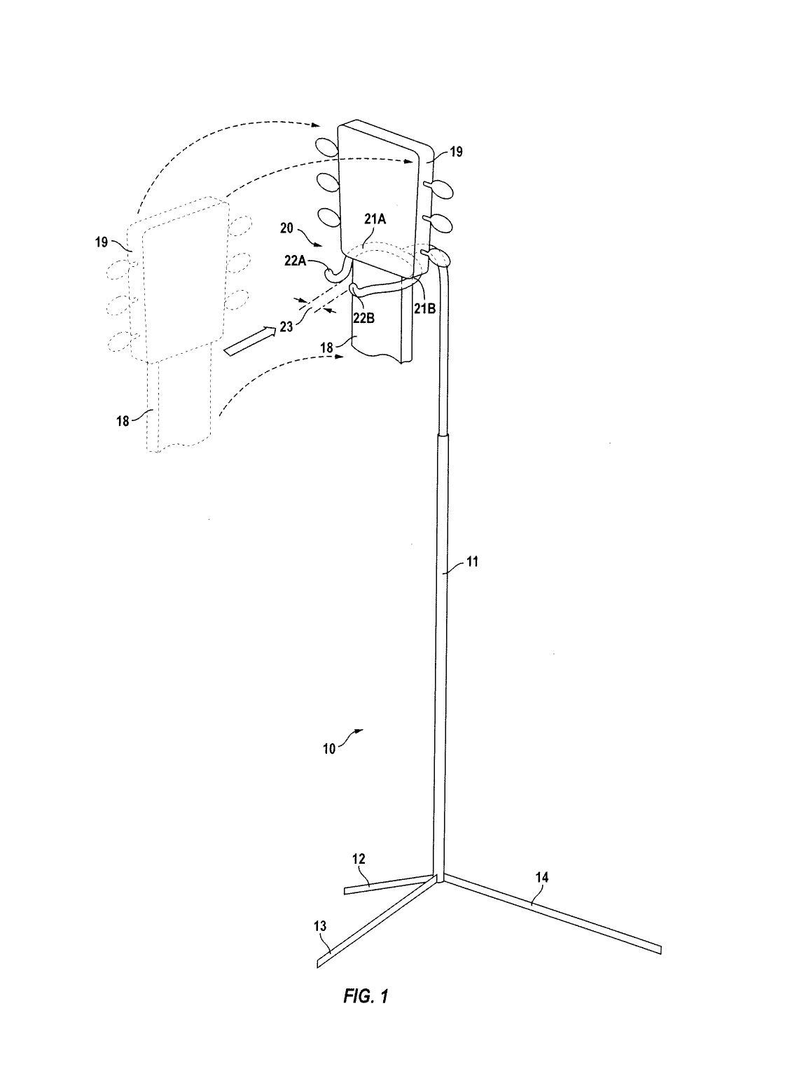

Turning first to FIG. 1, guitar hanger 10 is shown as a first embodiment. In this iteration, guitar hanger 10 is intended to support a guitar or similar musical instrument from a floor stand of the type typically located proximate a musician although such a stand can also be employed to store and display the instrument.

Guitar hanger 10 is intended to support a guitar or similar musical instrument having a neck 18 and head portion 19 shown in phantom as these components do not constitute the present invention but are only provided to inform the reader of the environment used in the practice of the present invention.

The support member of FIG. 1 is composed of vertically extending rod 11 which, in its preferred embodiment, can be telescoped to alter its length. Vertically extending rod 11 is appended to triangularly extending legs 12, 13 and 14 which, in turn, reside upon horizontally extending flooring (not shown). Ideally, legs 12, 13 and 14 can collapse upon vertically extending rod 11 for storage and portability of the present invention although these features do not constitute the invention per se.

The support member of vertically extending rod 11 and triangularly extending legs 12, 13 and 14 constitute support members for hanger 20. Hanger 20 is composed of a set of prongs 21A and 21B characterized as having converging ends spaced apart as spacing 23 so indicates. Ideally, prongs 21A and 21B terminate as upturned ends 22A and 22B that further assist in enabling the present guitar hanger to function as a device for minimizing inadvertent release of the guitar from its hanger.

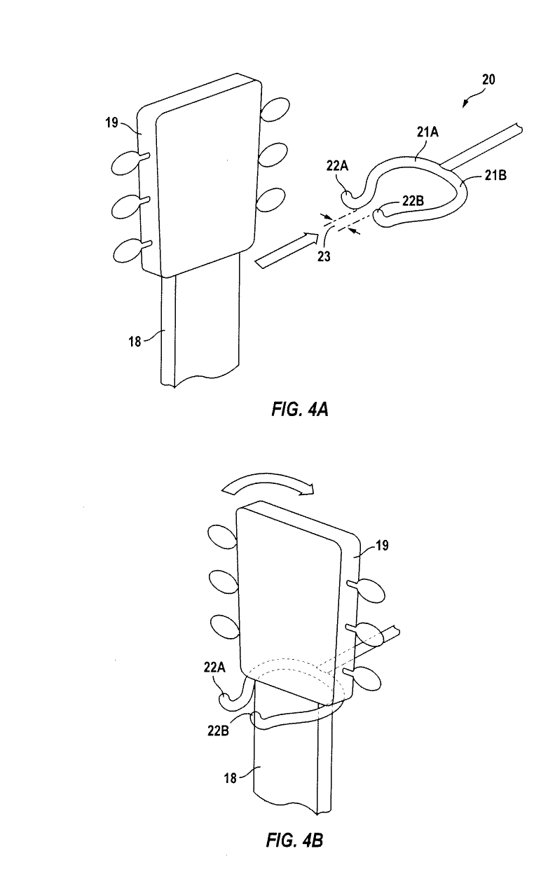

An important feature of the present invention is the creation of spacing 23 in conjunction with prongs 21A and 21B such that guitar neck 18 is capable of passing between the prongs in a first orientation but not in a second orientation. As such, the guitar would be incapable of being removed from the hanger by simply withdrawing the guitar straight out from its at-rest orientation. Instead, one would be required to rotate the guitar, preferably 90 degrees from its at-rest orientation, before sliding neck 18 from spacing 23. This is clearly shown in FIGS. 4A and 4B for if guitar 19 was presented in the orientation shown in 4B, it would never clear spacing 23. Only by rotating guitar 19 as shown in FIG. 4A can it slide within hanger 20.

It is quite apparent that the present invention offers certain advantages unrealized by the prior art. The most obvious advantage is that the guitar including head 19 and neck 18 cannot be removed from the hanger assembly without rotating the guitar and then withdrawing it from this assembly. This clearly minimizes if not completely eliminates the possibility of inadvertent removal and consequent damage to the musical instrument. Next, it should be readily apparent that the present invention is capable of functioning without complexity either in terms of the number of parts required to function in the present environment or in requiring the actuation of clips, hooks or elastic membranes in preventing the guitar from inadvertent removal from its hanger. As such, musicians are much more likely to employ the present invention than devices heretofore suggested by the prior art.

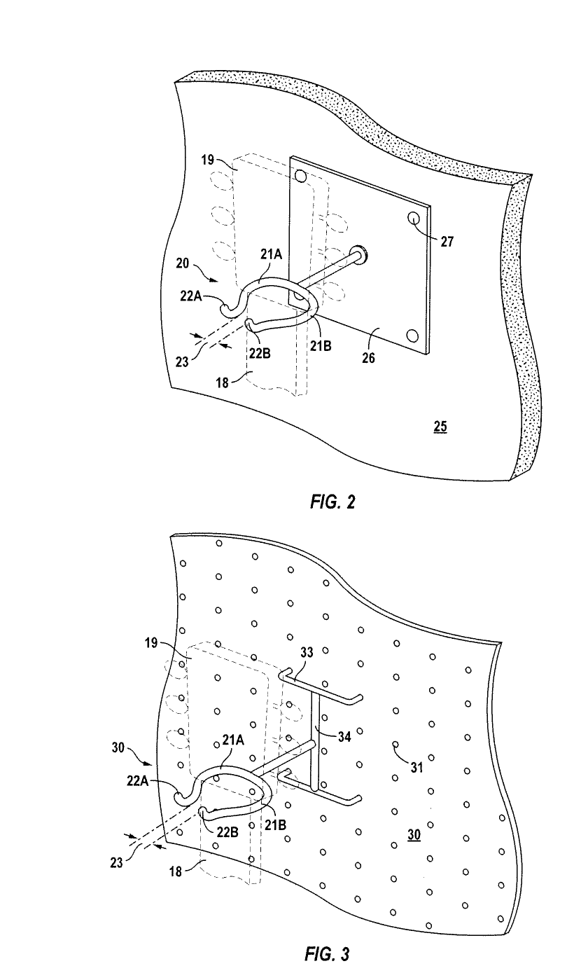

The present invention is also capable of being supported on a vertically extending wall. In this regard, reference is made to FIG. 2 whereby wall 25 which can typically be a sheet rocked member supported by studs acts as a receiving surface for connecting plate 26 which can be removably applied to wall 25 through the use of screws or other securing means 27. Because the present invention is somewhat light, even when supporting a musical instrument, securing members 27 could be sheet rock screws which releasably connect member 26 to wall 25. When a more secure attachment is desired, studs residing behind wall 25 can be located and wood screws applied through wall 25 to engage the studs. In any event, plate 26 can be employed to support hanger 20 which again can be composed of prongs 21A and 21B having upturned ends 22A and 22B and converging to spacing 23 for performing as suggested in reference to FIG. 1. The assembly of FIG. 2 is most likely to be employed in a permanent installation such as in one's home to securely and safely store a guitar or in a commercial setting where an instrument vendor wishes to display one or more guitars for perspective customers.

A less secure but nevertheless viable embodiment of the present invention is shown in FIG. 3. In this instance, peg board 30 consisting of pressed fiberboard having a series of spaced openings 31 can act as a supporting surface for hanger assembly 30. In this instance, horizontal and vertically extending rods 33 and 34 can be removably appended to peg board wall 30. Emanating from rods 33, 34 is the hanger assembly again comprised of prongs 21A and 21B terminating in upturned ends 22A and 22B converging to spacing 23 for vertically supporting a musical instrument such as a guitar. The benefits of the FIG. 3 embodiment over than shown in FIG. 2 is that the hanger assembly can be quite easily moved to different locations along peg board 30. However, pushing up upon the hanger assembly could inadvertently dislodge it from the pegboard so that when employing the embodiment of FIG. 3, additional care must be taken.

Regardless of which of the embodiments is employed, what is shown is a very user-friendly guitar hanger which protects the instrument from inadvertent dislodgement and yet which provides the instrument readily to a user or customer in which no moving parts are employed for carrying out this mission.

1. A guitar hanger for hanging and locking a guitar having a neck and a head portion, said hanger configured for hanging said guitar from its neck portion and for minimizing inadvertent release from said hanger comprising a support member and appended thereto, a set of prongs spaced apart from one another to receive said neck portion there between but not said head portion, said set of prongs further characterized as having converging ends spaced apart from one another such that said neck is capable of passing between said prongs in a first orientation but not in a second orientation.

2. The guitar hanger and locking device of claim 1 wherein said set of prongs are further characterized as having upturned ends for engaging said head portion.

3. The guitar hanger and locking device of claim 2 wherein said support member comprises a floor stand.

4. The guitar hangar and locking device of claim 3 wherein said floor stand comprises a vertically extending rod, proximate a first end of which is located said set of prongs and proximate a second end of which is located a plurality of legs extending there from.

5. The guitar hanger and locking device of claim 2 wherein said support comprises a base for placement onto a vertical wall and for being secured thereto.

6. The guitar hanger and locking device of claim 5 wherein said support further comprises a plurality of fasteners for releasably attaching said support to said vertical wall.

7. The guitar hanger and locking device of claim 2 wherein said support comprises a base for releaseable placement onto a vertical pegboard membrane.
